(19) United States
(12) Patent Application Publication
(10) Pub. No.: US 2004/0047044 A1
(43) Pub. Date: Mar. 11, 2004

(54) Apparatus and method for combining three-dimensional spaces

(76) Inventor: Michael Nicholas Dalton, London (GB)

Correspondence Address: TRASK BRITT, P.O. BOX 2550, SALT LAKE CITY, UT, 84110, US

(21) Appl. No.: 10/606,163

(22) Filed: Jun. 25, 2003

Related U.S. Application Data
(60) Provisional application No. 60/391,356, filed on Jun. 25, 2002.

(51) Int. Cl. G02B 27/14

(52) U.S. Cl. 359/630

(57) ABSTRACT

An apparatus and method for visually enhancing the ability to perform a medical procedure. The apparatus and method relates to an optical device configured to superimpose a display image over an object, wherein the display image aligns and corresponds with a portion of the object. The optical device includes a partial reflective device and a display member having a display surface configured to display the display image. The display member is oriented with respect to the partial reflective device such that the display image appears superimposed to a viewer over the object. With this arrangement, the display member displays an image that reflects with the partial reflective device and into a viewer's optical viewing path so that the viewer can see the displayed image through the partial reflective device superimposed over the object. The viewer may change the displayed image to another displayed image representing a portion further in depth into the object to obtain additional information with respect to the object.

### REFERENCE TO RELATED APPLICATIONS

This application claims the benefit of U.S. Provisional application No. 60\391,356, filed Jun. 25, 2002.

### BACKGROUND OF THE INVENTION

1. Field of the Invention

The present invention relates to an apparatus and method for visually combining an image with an object. More particularly, the present invention relates to a device and method for interposing a reflected image between an object and an individual or apparatus viewing the object for providing a physical collocation in real space of the object and image.

Visual perception is defined by both psychological (e.g. shading, perspective, obscuration, etc.) and physiological (convergence, accommodation, etc.) depth cues. Only the physiological depth cues are able to unambiguously discern the distance of points on an object from the viewer, since they arise from physiological changes in the vision system such as lens muscles contracting or expanding, or the movement of the eyes as they focus at different depths. If the vision system is to compare two objects, it is important they are perceived at the same depth, otherwise visual strain can result from differentially focusing between the objects. Strain arising from the visual system moving between the objects can be further reduced if the two objects are superimposed on each other. If one of these objects is a two-dimensional cross-section of a 3D object and is seen superimposed on the 3D object, it is important that the superimposed image is displayed at its correct distance within the object. Otherwise, the physiological depth cues will correctly inform the viewer that they are at different distances from the viewer, which can have serious consequences if the viewer is a surgeon.

1. State of the Art

Current techniques in the field of neurosurgery for displaying three-dimensional scanned information require the viewer to look away from the direct field of view to look at either two-dimensional cross-sectional or three-dimensional alternative representations of the anatomy on two-dimensional display devices. Typically these alternative representations are three-dimensional scans of the anatomy derived from a CT, MRI, PET or other types of three-dimensional scanners, and are displayed to aid the healthcare professional in navigating through the real anatomy.

For example, U.S. Pat. No. 6,167,296 to Shahidi discloses a surgical navigation system including a surgical pointer and a tracking system interconnected to a computer having data from an MRI or CT volumetric scan. The surgical pointer may be positioned on a portion of the patient's body, wherein the position of the pointer may be tracked in real time and conveyed to the computer with the volumetric scans. The computer then provides the real time images from the viewpoint of the pointer in combination with the volumetric scans to be displayed on a display screen to, thereby, allowing a surgeon to positionally locate portions on the patient's body with respect to the volumetric scans. While the Shahidi reference provides a device for positionally locating portions of a patient's body with respect to a volumetric scan, such device requires the surgeon to look away from the patient to the display screen to make comparisons between the position of the surgical pointer and the volumetric scan.

U.S. Pat. No. 5,836,954 to Heilbrum et al. discloses a device for defining a location of a medical instrument relative to features of a patient's body. The device includes a pair of video cameras fixed with respect to the patient's body to provide a real-time image on a display. The real-time image is aligned with a previously scanned image, such as an MRI, CT or PET scan, so that the medical instrument can be localized and guided to a chosen feature in the scan. In this manner, a surgeon can positionally locate the medical instrument with respect to the scan and the real-time image. However, such device requires the surgeon to look away from the patient to the display screen to locate the position of the medical instrument.

In each of the references discussed above, the medical practitioner is not able to optimize physiological and psychological depth cues during an operational procedure. Such physiological and psychological depth cues are triggered by objects when seen in their true three-dimensional space. The human visual system uses both physiological and psychological depth cues to determine relative positions in a three-dimensional space. The physiological depth cues include convergence, accommodation, binocular disparity and motion parallax. These physiological depth cues are the most important to professionals making critical decisions, such as neurosurgeons, yet these depth cues are not available in their field of view, in typical stereo-tactic displays. Therefore, it would be advantageous to medical practitioners to conduct medical procedures without substantial hampering of physiological and psychological depth cues.

### BRIEF SUMMARY OF THE INVENTION

The present invention relates to a method and apparatus for providing physical collocation of a real object and a projected image in real space. According to the present invention, the collocation of an object and a projected image may be accomplished by interposing a partially reflective device between an object and an individual viewing the object. An image to be collocated with the object may be projected to reflect from the partially reflective device such that an individual viewing the object through the partially reflected device also views the reflected image.

The ability of the present invention to visually create a collocated image with an object provides a tool and method for visually exploring the interior of an object without altering the physical characteristics of the object. For instance, the interior of an opaque object may be digitally represented as images produced by an electronic scan such as a CT scan, MRI scan, or the like. A series of scans may be combined to define a three-dimensional image of the object, including portions of the interior of the object. Cross-sections of the three-dimensional image may be projected onto the partially reflective device such that an individual viewing the object through the partially reflective device may see the cross-sectional image collocated within the object. This provides the viewer a unique look into the interior of the object.

The present invention may also be configured to accurately collocate an image of an interior portion of the object at a point in space corresponding with the actual portion of the object represented by the image. This provides an individual the ability to view a three-dimensional characterization of the object without altering the state of the object. Stated otherwise, the instant invention permits the user to “look” into the interior of an object without the need to cut into the object to reveal its interior. The invention provides a two-dimensional view of the interior of the object which can be transformed into a three-dimensional characterization through the viewing of multiple images over an extended period of time.

The partially reflected device for use with the various embodiments of the present invention may be part of an image projection device that also includes a display device, a computing system coupled to the display device, and a tracking system for tracking a position of the partially reflective device in a three-dimensional field about an object being viewed in accordance with the present invention. The display device may be used to project a desired image onto the partially reflective device and may include such things as computer displays, flat panel displays, liquid crystals displays, projection apparatuses, and the like. An image created by or stored in the computing system may be displayed on the display device and reflected off of the partially reflected device. The tracking system may be coupled with the computing system to track movement of the partially reflective device and to provide a reference point for determining the image to be displayed on the display device. Movement of the image projection device or the partially reflective device may be tracked by the tracking system and relayed to the computing system for updating the image displayed on the display device in accordance with the movement of the image projection device or partially reflective device.

In one embodiment of the present invention an image projection device includes a partially reflective device mounted a fixed distance from a display device. A computing system coupled with the display device includes one or more memories for storing data corresponding to images of an object. The computing system creates and displays images from the data stored in the memory of the computing system. A tracking system coupled to the computing system may be used to track the position of the partially reflective device within a three-dimensional space. The images created by the computing system and displayed on the display device may be altered by the movement of the partially reflected device as monitored by the tracking system. As the partially reflective device is moved, either manually or automatically, the display device also moves in a corresponding fashion such that the fixed distance and position between the partially reflected device and the display device remains constant. As the partially reflective device is moved within space around an object, the tracking system monitors the position of the partially reflective device and relays the position to the computing system. Based upon the position of the partially reflective device within space, the computing system creates a two-dimensional image of the object from the data stored in memory. The two-dimensional image is displayed on the display device and is reflected off of the partially reflective so that it may be viewed by a viewer. In this embodiment of the present invention, the image created by the computing system corresponds to the image that would appear a second fixed distance from the partially reflective device, the second fixed distance being the distance between the partially reflected device and a portion of the object being viewed. The second fixed distance is equal to the fixed distance between the partially reflective device and the display device. Thus, the image reflected off of the partially reflected device appears within the object a second fixed distance from the partially reflective device.

In another embodiment of the present invention, the partially reflective device and the display device may be operably coupled to a movement mechanism for controlling the movement of the partially reflective device and the display device. For instance, the movement mechanism may include a foot pedal control coupled to devices for moving the partially reflective device and display device as the foot pedal control is used. Alternatively, the movement mechanism may be controlled with a mouse-like control, a joystick, voice command system, or other device for receiving movement instructions and moving the partially reflective device and display device in accordance with the movement instructions. In this way preprogrammed view paths can be traced through the object.

In yet another embodiment of the present invention, the display device maybe moved relative to the partially reflective device such that the fixed distance between the display device and partially reflective device is altered. As the fixed distance between the display device and the partially reflective device is changed, the image reflected by the partially reflected device appears to move relative to the increase or decrease in distance between the partially reflective device and display device. The displayed images displayed by the display device may be altered in conjunction with the movement of the display device to reflect an image off of the partially reflective device corresponding to the distance between the partially reflective device and the display device.

In another embodiment of the present invention, the display device and computer system may be configured to change the display of an image without movement of the partially reflective device. An image displayed on the display device may include an image not associated with the object at the second fixed distance from the partially reflective device. The image displayed on the display device, and reflected from the partially reflective device, may instead be an image associated with a defined positive or negative distance from the second fixed distance. When displayed on the display device, the reflected image appears collocated with the object at a second fixed distance although the actual image being displayed is of that portion of the object a distance equal to the second distance plus or minus the defined distance. Using this embodiment of the present invention, a user may step forward or backward through reflected images to see portions of the object a further or shorter distance from the partially reflective device. In this way the viewer has a look-ahead capability without changing their focus from the current position. However, such disassociation of the reflected image position and the actual position within the object should be used with caution.

Other features and advantages of the present invention will become apparent to those of skill in the art through a consideration of the ensuing description, the accompanying drawings and the appended claims.

### BRIEF DESCRIPTION OF THE SEVERAL VIEWS OF THE DRAWINGS

While the specification concludes with claims particularly pointing out and distinctly claiming that which is regarded as the present invention, the invention may be further understood from the following description of the invention when read in conjunction with the accompanying drawings, wherein:

FIG. 1 illustrates a side perspective view of an optical space combining device in communication with an electronic system and tracking system, according to a first embodiment of the present invention;

FIG. 2 illustrates a front perspective view of an optical space combining device in communication with the electronic system and tracking system, according to a first embodiment of the present invention;

FIG. 3 illustrates a perspective side view of the optical space combining device in communication with an electronic system and tracking system, according to a second embodiment of the present invention; and.

FIG. 4 illustrates a perspective side view of the optical space combining device in communication with the electronic system, according to a third embodiment of the present invention.

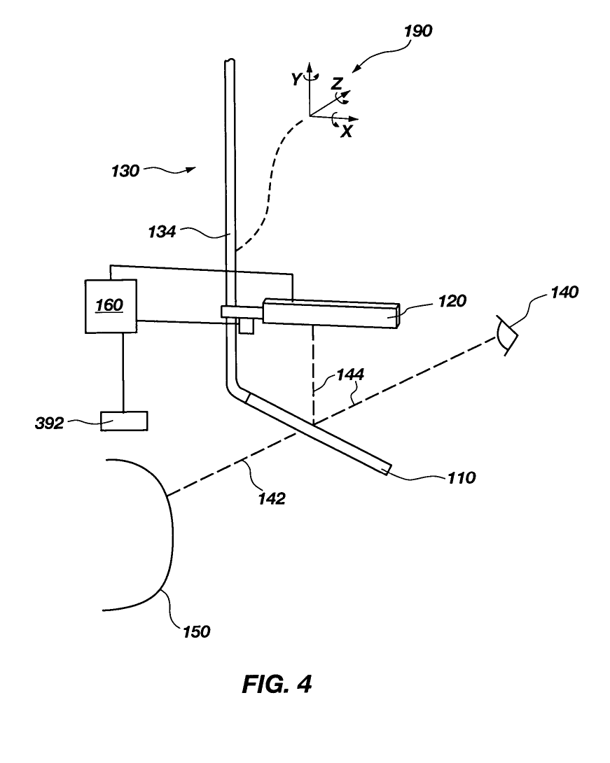

### DETAILED DESCRIPTION OF THE INVENTION

The various embodiments of the present invention are hereinafter described with reference to the accompanying drawings. It is understood that the drawings and descriptions are not to be taken as actual views of any specific apparatus or method of the present invention, but are merely exemplary, idealized representations employed to more clearly and fully depict the present invention than might otherwise be possible. Additionally, elements and features common between the drawing figures retain the same numerical designation.

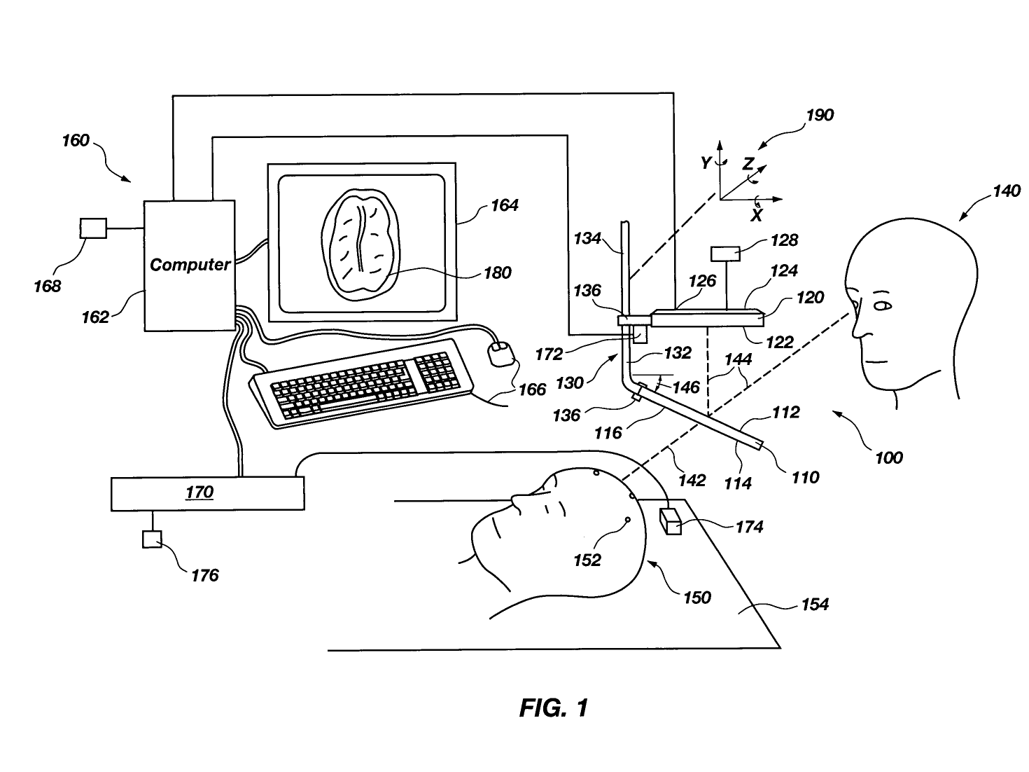

One embodiment of an image projection device 100 of the present invention that may be used to carry out the various methods embodied in the present invention is illustrated in FIG. 1. The image projection device 100 may include a partially reflective device 110, a display device 120, an imaging system 160, and a tracking system 170. The image projection device 100 may also include a carrier 130 to which the partially reflective device 110 and display device 120 may be moveably attached. Also illustrated in FIG. 1 are an object 150 and a view point 140.

The partially reflective device 110 may include any device that is transparent and is also able to reflect light. For instance, the partially reflective device 110 may include a device commonly referred to as a half-silvered mirror. A half-silvered mirror allows light to pass through the mirror while reflecting a portion of the light impinging on one surface of the mirror. As illustrated, the partially reflective device 110 includes both a first surface 112 and a second surface 114. If the partially reflective device 110 is a half-silvered mirror, light reflected off of object 150 passes from the object 150 through second surface 114 of the half-silvered mirror towards view point 140. A portion of light directed from display device 120 towards first surface 112 of the half-silvered mirror is reflected off of the first surface 112 back to the view point 140. Thus, light passes through the half-silvered mirror and is also reflected by the half-silvered mirror.

Additional devices capable of partially reflecting light and partially transmitting light through the device may be used as the partially reflective device 110 of the present invention. Like partial mirrors, such as a half-silvered mirror, polarized glass, glass plates, or plastic plates configured to both reflect and transmit light could be used. Furthermore, glass or plastic plates may be etched to alter the refractive qualities of the plate such that it could be used as a partially reflective device 110. Other devices, such as a liquid crystal container filled with liquid crystals, may be used as the partially reflective device 110 such that the amount of reflectance and transmittance may be controlled by a user of the partially reflective device 110. For example, variation of an electrical impulse to a liquid crystal container could alter the state of the liquid crystals in the container, thereby changing the amount of reflectance and transmittance realized by the liquid crystal container. The various embodiments of the present invention are not limited by the descriptions of the partially reflective devices 110 given herein.

The partially reflective device 110 may also include refraction altering films applied to one or more surfaces of the partially reflective device 110. For instance, an antireflecting film 116 may be applied to a second surface 114 of the partially reflective device 110 to prevent the reflection of light reflecting off of object 150. The use of an antireflective film 116 on a second surface 114 of the partially reflective device 110 helps to ensure that as much light as possible is transmitted through the partially reflective device 110 from object 150 to view point 140. Other filtering films, polarization films, and the like may also be used with or applied to the partially reflective device 110.

The display device 120 of the image projection device 100 may include any device capable of projecting or displaying an image. Any number of available display devices 120 may be used with the present invention, including such devices as a monitor screen, a flat panel display screen, a television tube, a liquid crystal display, an image projection device, and the like. The example display device 120 illustrated in FIG. 1 includes a display surface 122 recessed in a display housing 124. An input port 126 in the display housing 124 may accept or transmit data, input power to the display device 120, or provide other data communications. Data received at input port 126 may be converted to an image for display on display surface 122.

The partially reflective device 110 and the display device 120 may be moveably attached to a carrier 130 such that the display device 120 may be positioned a distance d, from the partially reflective device 110. Fastening devices such a bolts, screws, clamps, or other devices may be used to moveably attach the display device 120 and partially reflective device 110 to carrier 130. Alternatively, the display device 120 and partially reflective device 110 may be moveably attached to or fitted into defined portions of carrier 130 for holding or supporting the display device 120 or partially reflective device 110. In one embodiment, the carrier 130 may include two ends where one end terminates with the attachment to the partially reflective device 110 as illustrated in FIG. 1. In another embodiment, carrier 130 may include a track upon which a movable attachment device connected to display device 120 may be moved and fixed such that the display device 120 may easily move up and down carrier 130 to lengthen or shorten distance d₁.

Imaging system 160 provides data to display device 120 for producing an image on a display surface 122 of display device 120 or otherwise projecting an image from display device 120. As illustrated in FIG. 1, imaging system 160 may include a computer 162 with one or more memories 163, one or more storage devices 164, and coupled to one or more input devices 166 and displays 168. Computer 162 may include any type of computing system capable of storing and transmitting data. For instance, computer 162 may include a standalone computing system, a networked computing system, or other data storage and processing device capable of storing and transmitting image data to a display device 120. Storage devices 164 may include data storage devices and readers such as disk drives, optical drives, digital video disc drives, compact disc drives, tape drives, flash memory readers and the like. In an alternate embodiment of the present invention, the imaging system 160 may be incorporated with display device.

Image data corresponding to an object 150 may be stored in one or more memories 163 of the imaging system 160 or on media readable by storage devices 164. Image data may include data for constructing three-dimensional representations of objects or for creating two-dimensional planar views of a three-dimensional image. For instance, image data may include data developed from a CT scan of a portion of a human being, such as a CT scan of a person's head. The image data may be utilized, i.e. integrated, to construct a three-dimensional image of the person's head. Alternatively, the image data from the CT scan may be used to compile two-dimensional “slices” of the larger three-dimensional image. Each two-dimensional slice image created from the data represents a particular portion of the person's head at a definite location about the person's head. Other types of image data may include data developed from MRI scans, ultrasound scans, PET scans, and the like. Methods for collecting and storing image data that can be used with the various embodiments of the present invention are known. Furthermore, software and hardware for integrating image data into two-dimensional slices or three-dimensional images as used by the present invention are also known. Such software or hardware may operate on or with computer 162 to create images for display on display device 120 from the image data accessible to the imaging system 160.

The image projection device 100 of the present invention may also include a tracking system 170 for locating the position of the partially reflective device 110 or display device 120 within a three-dimensional space. The tracking system 170 may include any system capable of tracking the position of the partially reflective device 110 based upon coordinates along x, y, and z axes in a three-dimensional space. Furthermore, the tracking system 170 may also be configured to track the rotation of the partially reflective device 110 about the x, y, and z axes. The tracking system 170 may be operably coupled to the imaging system 160 to provide the location of the partially reflective device 110 such that the imaging system 160 may adjust the data sent to the display device 120 to alter the displayed image to correspond with the view of an object 150 from a view point 140 through the partially reflective device 110.

The tracking system 170 of the present invention monitors the position of the partially reflective device 110 relative to the object 150 and communicates the position to the imaging system 160. The imaging system 160 creates an image for display on display device 120 based upon the position of the partially reflective device 110 as monitored by the tracking system 170. For instance, tracking system 170 may include a receiver 172 and a transmitter 174. Transmitter 174 may transmit a magnetic field about object 150 and image projection device 100. The receiver 172 may include a device that disrupts the magnetic field created by transmitter 174. As the receiver 172 passes through the magnetic field created by transmitter 174, the transmitter 174 detects the interruption in the magnetic field and determines the position of the disruption. Coordinates corresponding with the disruption in the magnetic field may be passed by the transmitter 174 to the imaging system 160 to relay the position of the partially reflective device 110 within the magnetic field. Images created by imaging system 160 and displayed on display device 120 are based upon the position of the partially reflective device 110 within the magnetic field. For example, the transmitter 174 may be placed next to an object 150 to create a magnetic field about the object 150 and the image projection device 100. A receiver 172 mounted to the partially reflective device 110 creates disturbances in the magnetic field created by the transmitter 174. The transmitter detects the disturbances and the tracking system 170 communicates the coordinates of the disturbances to the imaging system 160. The imaging system 160 uses the coordinates received from the tracking system 170 to determine the data for creating an image on display device 120 and passing the data to the display device 120. The tracking system 170 of the present invention is not limited to a magnetic field disturbance tracking system as described. Other tracking methods or systems capable of monitoring the position of the partially reflective device 110 about an object 150 may be used.

According to the various embodiments of the present invention, an image displayed by display device 120 may be reflected off of the partially reflective device 110 such that a viewer positioned at view point 140 views a collocation of the displayed image with an object 150. The image projection device 100 may be positioned proximate an object 150 such that the object 150 may be viewed through the partially reflective device 110 from view point 140. In particular, the partially reflective device 110 and display device 120, preferably connected to carrier 130, are positioned proximate to object 150 for viewing object 150 through the partially reflective device 110 from view point 140. The position of the imaging system 160 is less important and the only requirement is that the imaging system 160 is capable of relaying data to display device 120 and receiving positioning coordinates from the tracking system 170. For instance, the imaging system 160 may be located remote to the display device 120 and partially reflective device 110 while remaining in communication with the display device 120 and tracking system 170 through wired communications, wireless communications, or other data exchange communications. Alternatively, the imaging system 160 may be incorporated with display device 120 such that the display device 120, partially reflective device 110, and carrier 130 are moveable about object 150 without any hindrance. The tracking system 170 may be integrated with the carrier 130 or positioned about object 150 and partially reflective device 110 so that the position of the partially reflective device 110 with respect to the object 150 may be monitored and coordinates relayed to the imaging system 160.

The positioning of the image projection device 100 about object 150 as monitored by the tracking system 170 dictates the image displayed by display device 120. The imaging system 160 constructs an image from data based upon the position of the image projection device 100 about the object 150 and more particularly, based upon the position of the partially reflective device 110 with respect to object 150. The image, or data representing the image constructed by the imaging system 160, is communicated to the display device 120 and the image is displayed on the display surface 122 of the display device 120. The displayed image is reflected off of the partially reflective device 110 in the viewing path 142 with the view of the object 150 from view point 140. The reflection of the displayed image off of the partially reflective device 110 in the viewing path 142, combined with the reflection of light off of the object 150 which passes through the partially reflective device 110 in viewing path 142, creates a dual image at view point 140 for a person or camera viewing the object 150 from view point 140. For instance, a person viewing object 150 through partially reflective device 110 from view point 140 would see both the object 150 and a reflection of the displayed image from display device 120. The combination of the reflection of the displayed image and the image of the object 150 as viewed through the partially reflective device 110 creates a physical collocation of the object 150 with the reflected image displayed on display device 120.

The various embodiments of the present invention provide methods for viewing imaged portions of an object 150 collocated, or superimposed, with the object 150. For example, an object 150 may be scanned using a CT scan and the data from the CT scan stored in an imaging system 160 or made accessible to the imaging system 160. The data from the CT scan may be constructed into images for display on display device 120. When an image created from a CT scan of an object 150 is displayed by display device 120, the image is also reflected off of partially reflective device 110. A viewer viewing the object 150 through the partially reflective device 110 views both the object 150 and the reflected image. To the viewer, the reflected image appears to be superimposed on, or within, the object 150. The apparent location of the image within the object 150 depends upon the distance between the display device 120 and the partially reflective device 110. In certain embodiments of the present invention, the display device 120 is mounted a fixed distance d₁ from the partially reflective device 110 as illustrated in FIG. 1. A reflected image of the display of the display device 120 off of partially reflective device 110 will appear to be a distance d₁′ from the partially reflective device 110 where distance d₁, and d₁′ are equal. If the distance between display device 120 and partially reflective device 110 is altered, the distance d₁ changes and the apparent location of an image reflected off of the partially reflective device 110 will also change to appear a distance d₁′ from the partially reflective device 110 where distance d₁ and d₁′ remain the same. Therefore, as the display device 120 is moved closer to the partially reflective device 110 the reflected image off of the partially reflective device 110 appears to move closer to the view point 140. Similarly, as the display device 120 is moved away from the partially reflective device 110 the reflected image appears to move further away from view point 140.

In certain embodiments of the present invention the distance between the display device 120 and the partially reflective device 110 is held at a constant distance d₁. The images displayed by display device 120 and reflected off of partially reflective device 110 in viewing path 142 appear to a viewer at a view point 140 to be a distance d₁′ from the partially reflective device 110. If a viewer is viewing an object through the partially reflective device 110, the reflected image is superimposed in the object 150 at a distance d₁′ from the partially reflective device 110. If the partially reflective device 110 and display device 120 are moved closer to the object 150, the reflected image appears to move through the object 150, maintaining a distance d₁′ from the partially reflective device 110. Likewise, if the partially reflective device 110 and display device 120 are moved away from the object 150 the reflected image appears to move through object 150 towards view point 140. At all times, the reflected image appears to be superimposed on the object 150 at a distance d₁′ from the partially reflective device 110.

Imaging systems, such as the imaging system 160 used with the present invention, provide the ability to create two-dimensional or three-dimensional images of an object 150 based upon imaging data taken of the object 150. For instance, data from a CT scan of an object may be constructed to create images of two-dimensional slices of the object 150. One example of such a system is used for medical purposes. A CT scan of a human's head may be conducted and the data used to recreate images of the interior portions of the head. Typically, the images created are two-dimensional images representing slices through the head. Three-dimensional images may also be created from the data. The data may be combined such that the two-dimensional images may be created from any angle. In other words, the images may be constructed to represent slices appearing along multiple planes, from multiple angles. Thus, images may be constructed as if a person was looking at the head from the side of the head, from the top of the head, from the bottom of the head, or from any other angle. Based upon the desired viewing angle, the imaging system 160 is capable of constructing an image of the head.

Furthermore, imaging systems may be used to step through an object 150 and create images of the object 150 based upon the desired location within the object 150. The ability of the imaging system 160 to create an image may depend upon the amount of data available to the imaging system 160 from the scan performed of the object 150. For instance, with respect to a human's head, a CT scan may be performed wherein the equivalent of twenty scans at a distance of 5 millimeters are taken. Images created from the data are limited to the data available. Thus, if a person wished to step through the images of the scanned head they may be limited to twenty images corresponding to the twenty scans performed. However, if one hundred scans were performed at a distance of 1 millimeter, one hundred images could be stepped through using the imaging system 160. In some instances, the imaging system 160 may be able to create a three-dimensional image from the scan data or be able to interpolate additional images based upon the overall three-dimensional structure of the object. An imaging system 160 capable of interpolating scan data into a three-dimensional image may be capable of creating as many images from the data as desired. Thus, a user could indicate that they wished to view two-dimensional images in one millimeter steps through the object 150 or in ⅕ millimeter steps through the object 150.

The combination of the imaging system 160 capabilities with the partially reflective device 110 and display device 120 of the present invention provides methods for altering the displayed images on the display device 120 so that different portions of the object 150 may be viewed as reflections off of the partially reflective device 110. Changing the displayed image changes the reflection so that a viewer viewing an object 150 through the partially reflective device 110 also sees the displayed portion of the object as it appears on the display device 120 superimposed on the object 150 at a distance d₁′ from the partially reflective device 110. Thus, the imaging system 160 may be instructed to create two-dimensional images of the object 150 from scan data of the object 150, and step through the data, creating and displaying images of each step through the object 150 on the display device. Thus, as a viewer views the object 150 through the partially reflective device 110 they may also see and step through the images created by the imaging system 160. However, unless the partially reflective device 110 and display device 120 are moved as images corresponding to different portions of the object 150 are displayed by imaging system 160, all of the images will appear superimposed on the object 150 at a distance d₁′ from the partially reflective device 110.

The tracking system 170 of the present invention may be combined with the imaging system 160, display device 120, and partially reflective device 110 to provide a dynamic system that allows a user to alter the reflected images based upon the positioning of the partially reflective device 110 with respect to an object 150. For instance, as the partially reflective device 110 is moved closer to the object 150 a reflected image created by the imaging system 160 and displayed on display device 120 appears to move through the object 150, maintaining a distance d₁′ from the partially reflective device 110. If the movement of the partially reflective device 110 with respect to the object 150 is tracked by tracking system 170, the tracking system 170 may communicate the distance moved to the imaging system 160 so that the imaging system 160 may alter the displayed image to correspond with an image of the object 150 at the distance d₁′ from the partially reflective device 110. Therefore, as the partially reflective device 110 is moved closer to the object 150 the displayed image changes to reflect that portion of the object 150 at the distance d₁′ from the partially reflective device 110. A person using the present invention to view an object 150 through partially reflective device 110 along with a reflected image of an interior portion of the object 150 could therefore “step through” the object 150 and view superimposed scanned images of the object by moving the partially reflective device 110 closer to or away from the object 150.

The collocation of a reflected image displayed by display device 120 with an object 150 such that a displayed image corresponds exactly with a portion of the object 150 a distance d₁′ from the partially reflective device 110 may be accomplished by coordinating the scanned images with the object 150. Coordination of the images with the movement of the partially reflective device 110 may be accomplished by aligning registration points of the object 150 with registration points recorded with the scanned data and setting the tracking system 170 to monitor movement based upon the registration. The coordination of the images with the object 150 may be accomplished by aligning known common points, such as registration points 152, appearing on the object 150 and in the displayed images. Two or more registration points 152 associated with object 150 may be aligned with registration points 152 appearing on images created from scanned data. Once aligned, the tracking system 170 may be set to monitor the movement of the partially reflective device 110 with respect to the object 150 based upon the registration. This provides a correlation between distance d₁′ from the partially reflective device 110 with the image displayed by imaging system 160 on display device 120 such that the displayed and reflected image viewed by a user is an image of the object 150 at the distance d₁′ from the partially reflective device 110.

An example of a process that may be used to register the tracking system 170 involves the placement of registration points on an object before obtaining scan data. For instance, an object 150, such as a human head, may be fixed with two or more registration points prior to a scan to obtain image data. The scanned data picks up and includes the positions of the registration points on the head. Viewing the head through the partially reflective device 110, the registration points on the head may be seen. Images created from the scan data and displayed by imaging system 160 on the display device 120 may be adjusted to show images corresponding to the scanned data of the registration points. The partially reflective device 110, with display device 120 fixed a distance d₁ from the partially reflective device 110, may be moved with respect to the object 150 until the registration points 152 on the object align with and correspond to the registration point images reflected off of the partially reflective device 110. Once the registration points 152 of the object 150 are aligned in space with the registration points on the images created by the imaging system 160, the tracking system 170 may be configured to base movement instructions sent to the imaging system 160 based upon the registration alignment.

As the tracking system 170 monitors the movement of the partially reflective device 110 with respect to an object 150, the tracking system 170 communicates the movement to the imaging system 160 which in turn alters the data sent to the display device 120 to alter the displayed image to correspond with the position within the object a distance d₁′ from the partially reflective device 110. The images displayed and reflected in viewing path 142 create a collocated image within object 150. This allows a user to explore the images of the interior of the object 150 from scan data collocated with the object 150.

The various embodiments of the present invention may be used in numerous applications where it is desirable to view an object 150 while simultaneously viewing scanned data representing images of portions of the object 150 collocated with the object. As an example, use of the present invention in the medical field is explained, however, it is understood that the examples do not limit the scope of the invention or the claims.

Neurosurgery is a delicate procedure, often requiring precise movements and attention to detail. To facilitate neurosurgical procedures imaged data of a person's head is often viewed before and during the neurosurgical procedure. Scanned images of the head may be stepped through and viewed on a monitor as the neurosurgeon performs an operation. To view the scanned images, the neurosurgeon glances away from the head, or operating object, to view a monitor displaying the scanned images. Although alternating views of the operating object and the monitor allow the surgeon to view scanned images, it is difficult to correlate the images with the operating object because they are not in the same view path or superimposed on each other.

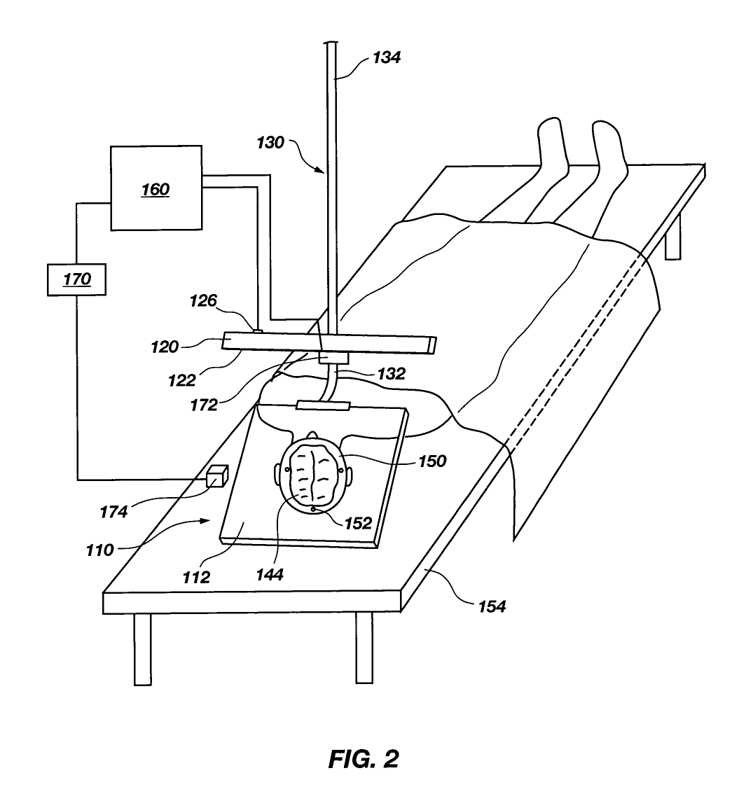

At least one embodiment of the present invention may be used to improve neurosurgical techniques. An image projection device 100 may be used during neurosurgery as illustrated in FIG. 2. The image projection device 100 may be used to display images of the scanned operating object 150 in the view path 142 of the surgeon 140. This allows the surgeon to view both the operating object 150 and images of the interior of the operating object during the surgery.

In one embodiment of the present invention, the head of a patient may be scanned, such as by a CT scan, MRI scan, PET scan, or the like, and the data stored in an imaging system 160 for creating two-dimensional images of the head. Registration points 152 may be applied to the head 150 prior to scanning to provide images with registration point 142 for calibrating the image projection device 100. In the operating room, the image projection device 100 may be located proximate to the head 150 of the patient such that a surgeon 140 may view the head 150 through the partially reflective device 110 of the image projection device 100. Before use, registration or calibration of the tracking system 170 is performed. The surgeon 140 aligns the registration points 142 on the head 150 with registration point 142 images created by the imaging system 160, displayed by display device 120 and reflected off of the partially reflective device 110. The tracking system 170 may be set or configured once the registration points 142 on the head and the images are aligned.

During surgery, the image projection device 100 may be used to view scanned images of the portions of the head 150 that the surgeon wishes to view. For instance, if the surgeon is working within the head 150 and they wish to see what is coming up next, in other words a portion of the head 150 that is not yet exposed by surgery, the surgeon may move the partially reflective device 110 closer to the head 150 thereby causing a displayed image associated with a portion of the head 150 a distance d₁′ from the partially reflective device 110 to be collocated with the head 150 by reflection off of the partially reflective device 110. The surgeon may move the partially reflective device 110 back, away from the head 150 to again view the portion of the head 150 where the surgery is taking place. Use of the partially reflective device 110 to perform such operations during surgery allows the surgeon to view, simultaneously, both the head 150 and a collocated image of a scan of the head 150.

Movement of the partially reflective device 110 during surgery may be accomplished manually or mechanically. The image projection device 100, and more importantly the partially reflective device 110, may be equipped with handles or other devices so that the partially reflective device 110 may be moved along and about an x-axis, y-axis, and z-axis. Alternatively, the partially reflective device 110 may be controlled by a mechanical device also capable of moving the partially reflective device 110 along and about an x-axis, y-axis, and z-axis. The control system may include movement controls such as a foot pedal, mouse, joystick, control panel, voice operated system, or other control mechanism for initiating movement of the partially reflective device 110. The amount of movement associated with a certain command issued to a mechanical control system may be altered and programmed as desired by the user. For instance, a surgeon may set the control system to provide one millimeter movements of the partially reflective device 110 upon each movement command issued to the control system. The movement distance could also be altered for another surgery or during a surgery if smaller or larger movement was desired. For example, once a surgeon reaches the portion of the head 150 where finer detail and more precision is required, the movement could be adjusted to one-half millimeter movement increments rather than one millimeter movement increments.

In another embodiment of the present invention, the surgeon may wish to advance the images produced by the imaging system 160 without moving the partially reflective device 110. In other words, the surgeon may wish to maintain the position of the partially reflective device 110 while viewing the next image or series of images that can be created by the imaging system 160. A control system, such as a foot operated control, hand operated control, voice operated control, or the like, may be integrated with the image projection device 100 to allow the surgeon to request movement through scanned images without movement of the partially reflective device 110. Based upon the request to the control system, the imaging system 160 may be instructed to advance or step through the scanned images. The amount of movement through the images, in other words, the step distance or increment, may be set to a desired amount using the control system. Using this system, a surgeon could move forward through the scanned images of an object without moving the partially reflective device 110. In instances where the images are altered without movement of the partially reflective device 110, the reflected image will appear superimposed on the object 150 but they will not be collocated within the object because the distance d₁′ does not change as the images are displayed. This function, however, allows a surgeon to view images of the object that they will be seeing as they move deeper into the head during surgery. Also, a reset function may be incorporated with the control system for resetting the image corresponding to the distance d₁′ on the display device 120 thereby providing collocation of the reflected image with the head 150.

In yet another embodiment of the present invention, the partially reflective device 110 of the image projection device 100 may be fixed to a neurosurgeons operating microscope or visual enhancement device. Images reflected off of the partially reflective device 110 are reflected into the microscope so that the surgeon views the images with the operating object, or head 150, view. This allows the surgeon to view scanned images of the operating object superimposed on the operating object.

In each of the embodiments of the present invention, the display of the images produced by the imaging system 160 may be terminated and reinstated at will. In other words, a user may turn the display on and off in order to view a superimposed or collocated image or to remove the image from view path 142. The display of the images may be turned on and off using manual or mechanical devices which may be integrated with control systems to allow voice control or manual control so the view of the object does not have to be disturbed to operate the display.

In an alternate embodiment of the present invention the image projection device 100 may be used in conjunction with real-time scanning equipment or an imaging system 160 conducting real-time scanning. Real-time scanning provides an image of an object in real-time. For instance, an ultrasound scan may be in progress while the image projection device 100 is being used. Images created from the ultrasound may be passed to the imaging system 160 and used with the image projection device 100. In another embodiment, helical scanners may be used with an object to scan the object while viewing the object through the partially reflective device 110. The integration of the image projection device 100 with real-time scanning is especially useful in surgical environments where a patient's body may be changing. For instance, during neurosurgery, portions of the brain may be altered by the surgery being performed or they may have changed since the time of the scan, such as with the growth of a tumor. Use of a real-time scanning device allows the imaging system 160 to produce images of the head or brain as the surgery is taking place. Thus, the image projection device 100 may be used to view real-time images collocated with the operating object during surgery.

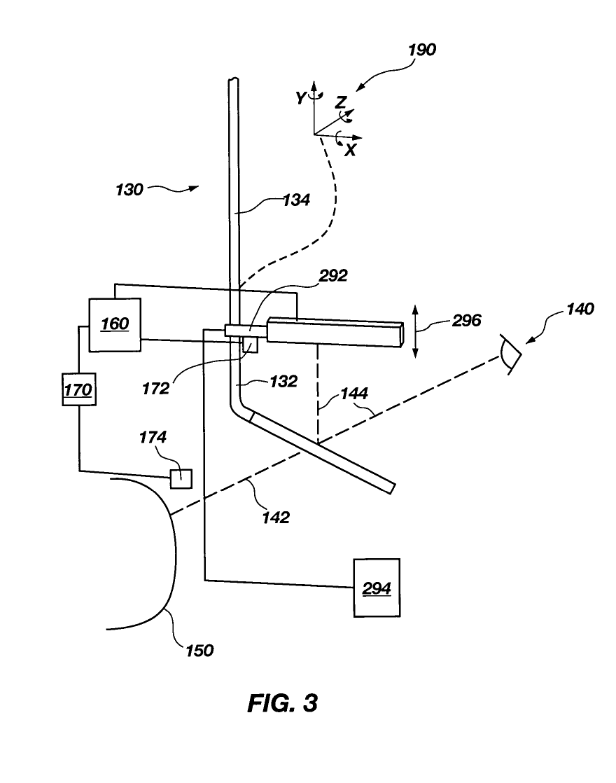

FIG. 3 illustrates a perspective side view of the image projection device 100 in communication with an electronic system and a tracking system, according to a second embodiment of the present invention. The second embodiment is substantially the same as the first embodiment, except the second embodiment includes a stepper 292 and a foot pedal 294. The stepper 292 may be an automated movable connector that is secured to the display device 120 and is movable by depressing the foot pedal 294. The stepper 292 and foot pedal 294 combination provide a controlled, stepped movement of the display device 120, wherein the receiver 172 should be in a fixed position with respect to said display device 120. As such, the tracking system 170 tracks the movement and position of the display device 120 and changes the scanned image 180 with respect to such movement as described in the first embodiment herein.

In the second embodiment, the movability of the image projection device 100 in combination with the tracking device 170 may still be utilized to determine the optimal position or optimal directional viewing course to examine the patient and object 150, by which the tracking system 170 provides the position of the image projection device 100 so that the computer 160 may generate a corresponding scanned image 180. Once such optimal position is determined by the viewer 140, the stepper 292 and foot pedal 294 combination provide the viewer 140 the ability to change the scanned image 180 along the optimal directional viewing course without having to manipulate the optical device manually, thereby, allowing the viewer to change the scanned image 180 with the viewer's hands free to continue performance of any medical procedures necessary.

Although the various embodiments are described where the partially reflective device 110 may sit suspended between the viewer and object, it is also contemplated that the partially reflective device 110 may be integrated on an ultrasound wand or other scanning device so that the partially reflective device 110 is reduced in size.

Having thus described certain preferred embodiments of the present invention, it is to be understood that the invention defined by the appended claims is not to be limited by particular details set forth in the above description, as many apparent variations thereof are possible without departing from the spirit or scope thereof as hereinafter claimed.

What is claimed is:

1. An optical space combining device configured to superimpose one image over an object, the device comprising:
a partial reflective device having a front surface and a back surface; and
a display member having a display surface configured to display a display image, said display member configured to be oriented with respect to said partial reflective device so that said display image appears superimposed to a viewer over the object.

2. The device of claim 1, wherein said display member is fixable in a position with respect to said partial reflective device.

3. The device of claim 1, wherein said display member is movable with respect to said partial reflective device.

4. The device of claim 3, wherein said display member maintains a constant orientation with respect to said partial reflective device.

5. The device of claim 1, wherein said display member is movably rotatable with respect to said partial reflective device.

6. The device of claim 2, wherein both of said partial reflective device and said display member is movable with respect to the object.

7. The device of claim 2, wherein both of said partial reflective device and said display member are movable with respect to the object with at least one of six degrees of freedom.

8. The device of claim 1, wherein said display image substantially corresponds with at least a portion of the object.

9. The device of claim 1, wherein said display image comprises a scanned image taken from a three-dimensional scanned image of at least a portion of the object.

10. The device of claim 1, wherein said display image comprises a real-time image.

11. The device of claim 1, wherein said display image comprises an interpolation taken from multiple images.

12. The device of claim 1, wherein said display image comprises multiple images taken from the object.

13. The device of claim 1, wherein said display image comprises multiple images that are displayed on said display member upon moving at least one of said display member and said optical combining device.

14. The device of claim 1, wherein said display image comprises multiple images configured to singularly display on said display member.

15. The device of claim 1, wherein said display image changes among said multiple images by triggering an image changing device.

16. The device of claim 1, wherein said partial reflective device comprises a half silvered mirror.

17. The device of claim 1, wherein said partial reflective device comprises an antireflective film disposed adjacent at least one of said front surface and said back surface thereof.

18. A system comprising:
a computer having at least one input device and at least one output device; and
an optical combining device coupled to said computer, said optical combining device including:
a partial reflective device having a front surface and a back surface; and
a display member having a display surface configured to display a display image, said display member configured to be oriented with respect to said partial reflective device so that said display image appears superimposed to a viewer over an object.

19. The system of claim 18, further comprising a tracking system coupled to said computer.

20. The system of claim 19, wherein said tracking system comprises a transmitter device and a receiver device.

21. The system of claim 20, wherein said transmitter comprises a magnetic field for tracking a position of said receiver.

22. The system of claim 20, wherein said transmitter comprises a magnetic field for tracking a position of said at least one of said partial reflective device and said display member.

23. The system of claim 21, wherein said receiver device is positionally fixed with respect to at least one of said partial reflective device and said display member.

24. The system of claim 18, wherein said computer facilitates multiple display images, wherein said multiple display images comprises said display image.

25. The system of claim 24, wherein said multiple display images each substantially corresponds with at least a portion of the object.

26. The system of claim 24, wherein said multiple display images comprised of three-dimensional volumetric scan of at least a portion of the object.

27. The system of claim 26, wherein said display image changes among said multiple images by the viewer triggering an image changing device.

28. The system of claim 18, further comprising an image changing device for changing said display image among multiple display images, said image changing device triggerable by the viewer.

29. The system of claim 18, wherein said display image comprises a scanned image taken from a three-dimensional scanned image of at least a portion of the object

30. The system of claim 18, wherein said display image comprises a real-time image.

31. The system of claim 18, wherein said display image comprises an interpolation taken from multiple images.

32. The system of claim 18, wherein said display image comprises multiple images taken from the object.

33. The system of claim 18, wherein said display image comprises multiple images that are displayed on said display member upon moving at least one of said display member and said optical combining device.

34. The system of claim 18, wherein said partial reflective device comprises a half silvered mirror.

35. The system of claim 18, wherein said display member is fixable in a position with respect to said partial reflective device.

36. The system of claim 35, wherein at least one of said partial reflective device and said display member is movable with respect to the object.

37. The system of claim 35, wherein at least one of said partial reflective device and said display member are movable with respect to the object with at least one of six degrees of freedom.

38. A method of superimposing one image over an object in a medical procedure, the method comprising:
providing a partial reflective device having a front surface and a back surface;
providing a display member having a display surface configured to display a display image; and
orienting said display member with respect to said partial reflective device so that said display image appears superimposed over an object to a viewer.

39. The method of claim 38, further comprising providing a computer having at least one input device and at least one output device, said computer coupled to said display member.

40. The method of claim 39, further comprising providing a tracking system coupled to said computer, said tracking system having a transmitter device and a receiver device.

41. The method of claim 40, further comprising tracking a position of said at least one of said partial reflective device and said display member with respect to said object.

42. The method of claim 41, wherein said tracking comprises displaying a scanned image that corresponds with a portion of said object.

43. The method of claim 39, wherein said providing said computer comprises storing multiple scanned images, each of which represent a portion of the object.

44. The method of claim 39, wherein said providing said computer comprises configuring said computer to store multiple scanned images and to display said display image on said display member taken from at least one of said multiple scanned images.

45. The method of claim 44, further comprising changing said display image among said multiple images by the viewer triggering said image-changing device.

46. The method of claim 44, wherein said configuring comprises forming said display image by interpolating from said multiple scanned images.

47. The method of claim 44, wherein said providing said computer comprises providing multiple scanned images in said computer each representing portions of the object.

48. The method of claim 38, further comprising maneuvering at least one of said partial reflective device and said display member with respect to the object with at least one of six degrees of freedom.

49. The method of claim 48, wherein said maneuvering comprises aligning said display image with said object in an optical viewing path of the viewer.

50. The method of claim 48, wherein said maneuvering comprises aligning said display image to reflect in an optical viewing path of the viewer to appear superimposed with said object.

51. The method of claim 48, wherein said maneuvering comprises aligning said display image with said object so that at least a portion of said display image that represents said object appears to be substantially superimposed there over.

52. The method of claim 38, wherein said orienting comprises reflecting said display image against said partial reflective device in an optical viewing path of the viewer.
